(19) United States
(12) Patent Application Publication
(10) Pub. No.: US 2022/0240604 A1
(43) Pub. Date: Aug. 4, 2022

(54) PORTABLE PROTECTIVE DEVICE FOR PREVENTING RESPIRATORY VIRUSES

(71) Applicants: Young Tae KIM, Seoul (KR); DAESUNG INDUSTRIAL CO., LTD, Seoul (KR); YOUNG CONSULTING LTD., Seoul (KR)

(72) Inventor: Young Tae KIM, Seoul (KR)

(73) Assignees: Young Tae KIM, Seoul (KR); DAESUNG INDUSTRIAL CO., LTD, Seoul (KR); YOUNG CONSULTING LTD., Seoul (KR)

(21) Appl. No.: 17/586,954

(22) Filed: Jan. 28, 2022

(30) Foreign Application Priority Data
Feb. 2, 2021 (KR) 10-2021-0014983

(51) Int. Cl. A41D 13/11; A62B 7/10; A62B 23/02

(52) U.S. Cl. CPC A41D 13/1184; A41D 13/1161; A62B 23/02; A62B 7/10; A41D 13/1107

(57) ABSTRACT

The present disclosure relates to a portable protective device for preventing respiratory viruses, which is characterized in that a face shield can be worn in close contact with the user's face to prevent the user's eyes and respiratory organs from being exposed to the outside, whereby it is possible to prevent permeation of contaminated air by supplying purified air through an air purifier, and to enable a user to take drink, etc. while minimizing exposure to respiratory viruses because an insertion port for inserting a straw to enable the user to take drink such as coffee is provided.

### CROSS REFERENCE TO RELATED APPLICATIONS

This Application claims the benefit of Republic of Korea Patent Application No. 10-2021-0014983, filed on Feb. 2, 2021, the entire disclosures of which are incorporated by reference herein.

### BACKGROUND OF THE DISCLOSURE

### Technical Field

The present disclosure relates to a portable protective device for preventing respiratory viruses. More particularly, the present disclosure relates to a portable protective device for preventing respiratory viruses which is configured such that a face shield can be worn in close contact with the user's face to prevent the user's eyes and respiratory organs from being exposed to the outside, which can prevent permeation of contaminated air by supplying purified air through an air purifier, and which enables a user to take drink, etc. while minimizing exposure to respiratory viruses because it has an insertion port for inserting a straw to enable the user to take drink such as coffee.

### Background Art

Entering the 2000's, infectious diseases such as SARS, MERS, and COVID have frequently raged and infectious diseases generated in some areas have spread all over the world, so not only casualties, but a tremendous economic loss have been generated due to the infectious diseases.

In particular, as for recently raging COVID-19, it is extremely infectious, so it is recommended to wear a mask as a daily prevention means against the strong infectiousness and high-quality filter masks having a filtering function to prevent permeation of viruses, etc. are on the market.

A ‘Personal sanitary mask with light filter’ has been disclosed in Korean Patent Application Publication No. 10-2020-0020747 (hereafter, referred to as ‘patent document 1’).

Referring to the patent document 1, the ‘personal sanitary mask with a light filter’ in the related art includes: an outer housing that maintains the shape in close contact with a face; an air passage that is coupled to the outer side of the outer housing and is composed of several holes passing air for respiration; a light source module that decomposes the DNA of viruses in the air provided for respiration by emitting light with disinfection wavelength into the air passage; a power switch that applies power to the light source module; a light source that supplies power to the light source module; and a light filter that is equipped with a power converter converting the current and voltage output from the power source into current and voltage that are suitable for the light source module, in which an inner mask that serves to prevent light from being directly emitted to a skin, to filter out harmful substances, and to maintain antibiosis by being applied with a light catalyst is coupled inside the outer housing maintaining the shape of the mask through a coupler.

According to the patent document 1 having this configuration, UV light having a disinfection wavelength is stably emitted from the light source module and the emitted light always sterilizes the air for respiration and the inner mask, so not only there is an economic effect of an increase in lifespan of the mask, but contaminated or exhausted parts can be replaced through a detachable structure. However, there is a problem that when a user uses the mask for a long period of time, the mask gets wet due to humidify, so the user feels unpleasant.

Further, there is a problem that when a user moves the facial muscles with the mask on, the upper and lower portions of the mask being in contact with the ridge of the nose and the jaw come off due to the curves of the face, so it is difficult to efficiently block viruses. Further, there is a problem that it is necessary to take off the mask to take drink such as coffee, the user is unavoidably exposed to respiratory viruses.
(Patent document 1) Korean Patent Application Publication No. 10-2020-0020747

### SUMMARY

### Technical Problem

The present disclosure has been made in an effort to solve the problems and an objective of the present disclosure is to provide a portable protective device for preventing respiratory viruses which is configured such that a face shield can be worn in close contact with the user's face to prevent the user's eyes and respiratory organs from being exposed to the outside, which can prevent permeation of contaminated air by supplying purified air through an air purifier, and which enables a user to take drink, etc. while minimizing exposure to respiratory viruses because it has an insertion port for inserting a straw to enable the user to take drink such as coffee.

Another objective of the present disclosure is to provide a portable protective device for preventing respiratory viruses which enables a user to take food while minimizing exposure to respiratory viruses when the user takes food at a restaurant, etc., because it has a mouth shield that is disposed at a lower portion of a face shield and of which the angle can be adjusted by rotating up and down.

### Technical Solution

In order to solve the problems described above, a portable protective device for preventing respiratory viruses according to a first embodiment of the present disclosure includes: a face shield that can be worn on a user's face while covering user's eyes, nose, and mouth, has an air inlet for taking inside external air at a top thereof, and has an air passage formed around an edge thereof to form a passage through which air is discharged outside when the user respires; a respiration guide that is coupled to surround a rear of the face shield, is brought in close contact with the user's face, and has a diaphragm at a center thereof to separate the eyes and respiratory organs of the user; an air purifier that is connected to the air inlet on the top of the face shield and purifies and supplies external air to the air inlet; and a fastening band that is connected to the rear of the face shield to be worn on a rear part of a user's head, in which an air intake hole is formed at the diaphragm so that air purified through the air purifier flows to the respiratory organs of the user through the air inlet, and a check valve that opens the air intake hole when the user breathes in and closes the air intake hole when the user breathes out is installed inside the diaphragm.

A portable protective device for preventing respiratory viruses according to a second embodiment of the present disclosure includes: a face shield that can be worn on a user's face while covering user's eyes and nose and has an air inlet for taking inside external air at a top thereof; a respiration guide that is coupled to surround a rear of the face shield, is brought in close contact with a user's face, and has a diaphragm at a center thereof to separate the eyes and the nose of the user; an air purifier that is connected to the air inlet on the top of the face shield and purifies and supplies external air to the air inlet; a fastening band that is connected to the rear of the face shield to be worn on a rear part of a user's head; and a mouth shield that is coupled to a lower portion of the face shield and prevents a user's mouth from being exposed to the outside, in which an air intake hole is formed at the diaphragm so that air purified through the air purifier flows to the respiratory organs of the user through the air inlet, and a check valve that opens the air intake hole when the user breathes in and closes the air intake hole when the user breathes out is installed inside the diaphragm.

The air purifier includes: a first filter for primarily filtering out relative large particles; and a second filter for secondarily filtering ultrafine contaminant particles on a rear of the first filter.

An opening-closing type filter unit that is positioned ahead of the user's mouth to be able to open when the user talks is disposed at a lower portion of the face shield, and a filter is installed in the opening-closing type filter unit to prevent permeation of respiratory viruses.

The opening-closing type filter unit includes: a rotary guide that has several air outlets spaced apart from each other with regular intervals therebetween so that voice of the user can be transmitted to the outside; and opening/closing plates that are coupled to the rotary guide to open/close the air outlets by rotating to a side or another side by the user.

The opening/closing plate has a hole that is biased from the air outlet when the opening/closing plate is rotated to a side and that communicates with the air outlet when the opening/closing plate is rotated to another side, and a handle that is provided to easily rotate the opening/closing plate.

An edge of the rotary guide is partially cut to limit a rotation range of the opening-closing plates, whereby stopping steps are formed at both sides.

An insertion port through which a straw S is inserted so that the user can take drink and a cap for opening/closing the insertion port are formed at a center of the opening/closing type filter unit.

A glasses seat is formed on two sides of an inner surface of the respiration guide to prevent interference with an eyeglass frame when the user wears glasses, and a fixing groove for fixing a temple is formed at an end of the glasses seat.

The mouth shield is configured to be rotatable.

### Advantageous Effects

According to the present disclosure, there is an advantage that a face shield can be worn in close contact with the user's face to prevent the user's eyes and respiratory organs from being exposed to the outside, whereby it is possible to prevent permeation of contaminated air by supplying purified air through an air purifier, and to enable a user to take drink, etc. while minimizing exposure to respiratory viruses because an insertion port for inserting a straw to enable the user to take drink such as coffee is provided.

Further, there is an advantage that since the mouth shield of which the angle can be adjusted is installed at the lower portion of the face shield and can block viruses, so it is possible to take food while minimizing exposure to respiratory viruses when taking food at a restaurant, etc.

### BRIEF DESCRIPTION OF THE DRAWINGS

FIG. 1 is an exploded perspective view of a portable protective device for preventing respiratory viruses according to a first embodiment of the present disclosure.

FIG. 2 is a perspective assembly view of the portable protective device for preventing respiratory viruses according to the first embodiment of the present disclosure.

FIGS. 3a and 3b are views showing the worn state of the portable protective device for preventing respiratory viruses according to the first embodiment of the present disclosure.

FIG. 4 is a view showing the state in which a user wearing the portable protective device for preventing respiratory viruses according to the first embodiment of the present disclosure takes drink.

FIG. 5 is a view showing the flow state of air when a user wearing the portable protective device for preventing respiratory viruses according to the first embodiment of the present disclosure respires.

FIG. 6 is a view showing the method of using an opening-closing type filter unit of the portable protective device for preventing respiratory viruses according to the first embodiment of the present disclosure respires.

FIG. 7 is a perspective assembly view of a portable protective device for preventing respiratory viruses according to a second embodiment of the present disclosure.

FIGS. 8a and 8b are views showing the worn state of the portable protective device for preventing respiratory viruses according to the second embodiment of the present disclosure.

FIG. 9 is a view showing the state in which a user wearing the portable protective device for preventing respiratory viruses according to the second embodiment of the present disclosure takes drink.

FIG. 10 is a view showing the flow state of air when a user wearing the portable protective device for preventing respiratory viruses according to the second embodiment of the present disclosure respires.

### DESCRIPTION OF EXEMPLARY EMBODIMENTS

Hereafter, the present disclosure is described in detail with reference to the drawings. Like reference numerals given in the drawings indicate like components.

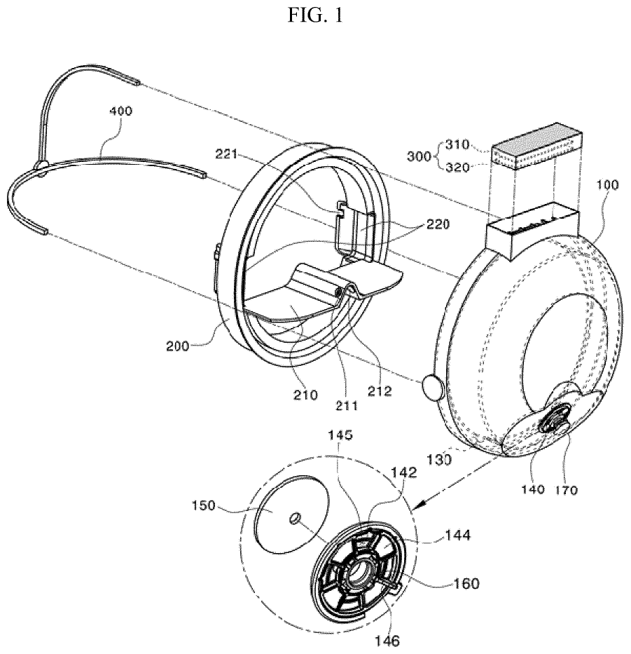

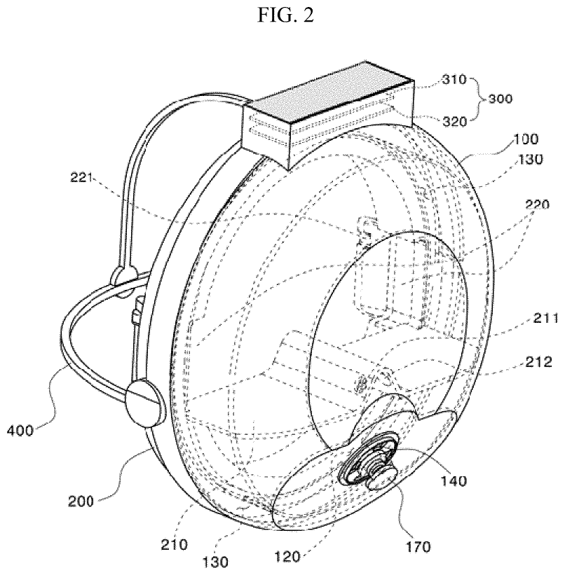

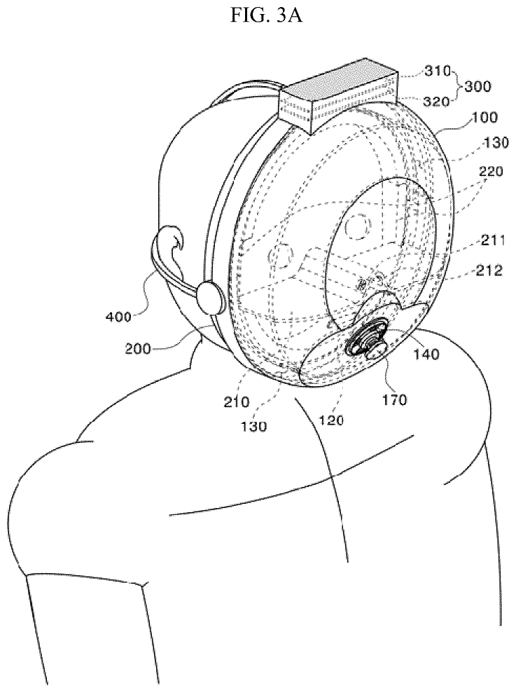

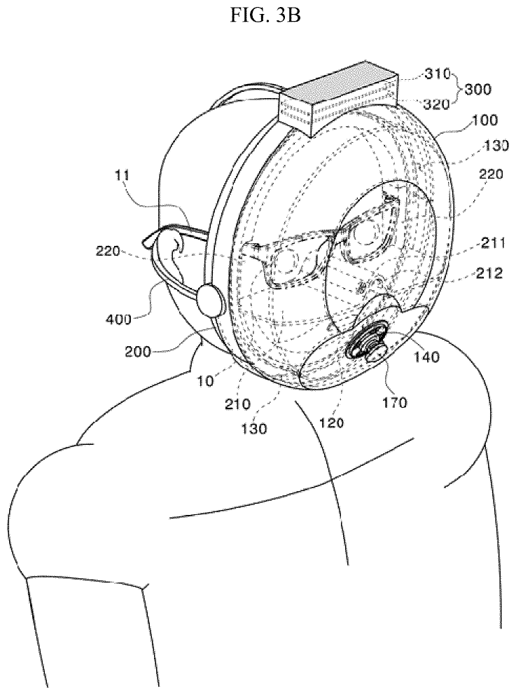

FIG. 1 is an exploded perspective view of a portable protective device for preventing respiratory viruses according to a first embodiment of the present disclosure, FIG. 2 is a perspective assembly view of the portable protective device for preventing respiratory viruses according to the first embodiment of the present disclosure, and FIGS. 3a and 3b are views showing the worn state of the portable protective device for preventing respiratory viruses according to the first embodiment of the present disclosure.

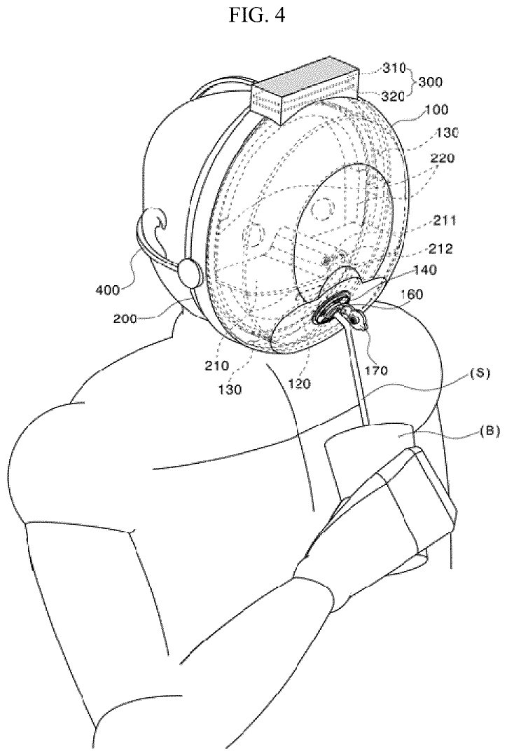

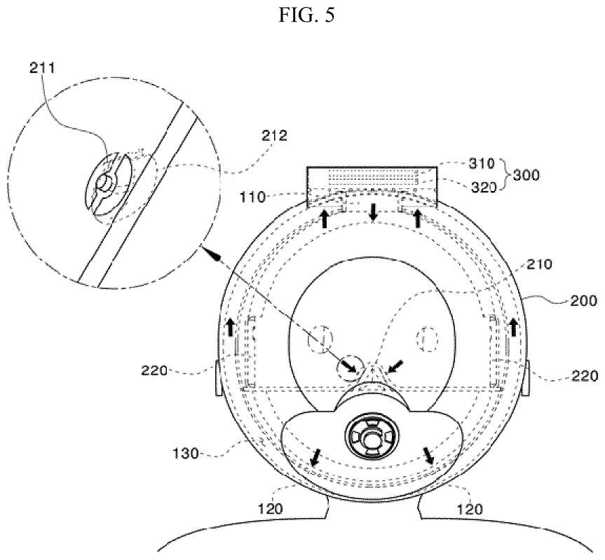

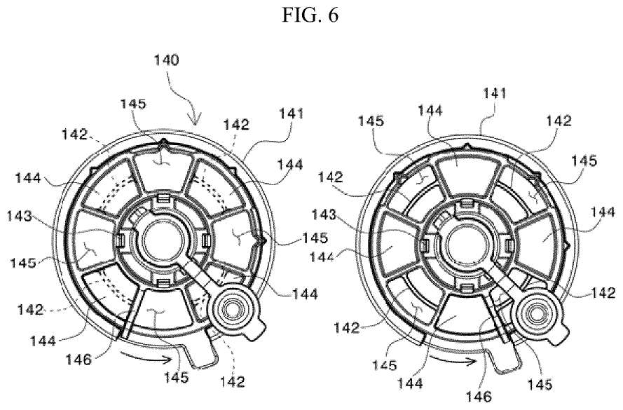

FIG. 4 is a view showing the state in which a user wearing the portable protective device for preventing respiratory viruses according to the first embodiment of the present disclosure takes drink, FIG. 5 is a view showing the flow state of air when a user wearing the portable protective device for preventing respiratory viruses according to the first embodiment of the present disclosure respires, and FIG. 6 is a view showing the method of using an opening-closing type filter unit of the portable protective device for preventing respiratory viruses according to the first embodiment of the present disclosure respires.

Referring to FIGS. 1 to 6, a portable protective device for preventing respiratory viruses according to a first embodiment of the present disclosure includes a face shield 100, a respiration guide 200, an air purifier 300, and a fastening band 400.

The face shield, which is can be worn on the user's face while covering the user's eyes, nose, and mouth, is preferably made of a transparent material so that a user can secure the front visual field when wearing the device.

The present disclosure is characterized in that an air inlet 110 for taking inside external air is provided at the top of the face shield 100. The air purifier 300 is connected to the air inlet 110. External air purified through the air purifier 300 flows to the upper portion of the face shield 100, so the user can breathe with the purified air, so it is possible to prevent the respiratory organs from being exposed to respiratory viruses.

An air passage 130 is formed around the edge of the face shield 100 to form a passage through which air is discharged outside when the user respires. An air hole 120 is formed at the front end of the air passage hole 120 so that air can move to the air passage 130.

An opening-closing type filter unit 140 that is positioned ahead of the user's mouth to be able to open when the user talks is disposed at the lower portion of the face shield 100. It is preferable that a filter 150 is installed in the opening-closing type filter unit 140 to prevent permeation of respiratory viruses.

The opening-closing type filter unit 140, as shown in FIG. 6, includes a rotary guide 141 having several air outlets 142 spaced apart from each other with regular intervals therebetween so that the voice of a user can be transmitted to the outside, and opening/closing plates 144 coupled to the rotary guide 141 to open/close the air outlets 142 by rotating to a side or another side by a user. The opening/closing plate 144 has a hole 145 that is biased from the air outlet 142 when the opening/closing plate 144 is rotated to a side and that communicates with the air outlet 142 when the opening/closing plate 144 is rotated to another side. Further, a handle 146 is provided to easily rotate the opening/closing plates 144.

The rotary guide 141 has coupling protrusions 143 formed around the center thereof with regular intervals therebetween so that the rotary guide 141 can be coupled to the opening/closing plates 144. The edge of the rotary guide 141 is partially cut to limit the rotation range of the opening-closing plates 144, whereby stopping steps are formed at both sides.

Meanwhile, the present disclosure is characterized in that an insertion port 160 through which a straw S is inserted is formed at the lower portion of the face shield 100 which corresponds to the user's mouth, as shown in FIG. 4, so that a user can take drink B such as coffee. A cap 170 that opens/closes the insertion port 160 is provided at the insertion port 160 to be able to open the insertion port 160 only when a user takes drink while closing the insertion port 160 when a user does not take drink. Accordingly, a user wearing the face shield 100 can safely take drink while being minimally exposed to respiratory viruses.

The respiration guide 200 is coupled to surround the rear of the face shield 100 and is brought in close contact with the user's face. It is preferable that the respiration guide 200 is made of rubber materials such as silicone, rubber, neoprene, nitrile rubber, butyl rubber, hypalon, ethylene propylene, and fluoro rubber so that it can be brought in close contact with the user's face.

The present disclosure is characterized in that a diaphragm 210 is disposed at the center of the respiration guide 200 to separate the eyes and the respiratory organs of a user. One or more air intake holes 211 are formed at the diaphragm 210 so that the air purified through the air purifier 300 moves to the respiratory organs of a user through the air inlet 110. It is preferable that a check valve 212 is installed inside the diaphragm 210 to open the air intake hole 211 when a user breathes in and to close the air intake hole 211 when a user breathes out.

The diaphragm 210 is configured to separate the user's eyes and respirator organs, thereby preventing the face shield 100 from being fogged when a user respires with the face shield 100 on.

A glasses seat 220 is formed on two sides of the inner surface of the respiration guide 200, as shown in FIG. 3b, to prevent interference with an eyeglass frame 10 when a user wears glasses. It is preferable that a fixing groove 221 for fixing a temple 11 is formed at the end of the glasses seat 220.

The air purifier 300 is connected to the air inlet 110 on the top of the face shield 100 and purifies and supplies external air to the air inlet 110. The air purifier 300 includes a first filter 310 for primarily filtering out relatively large contaminant particles and a second filter 320 for secondarily filtering ultrafine contaminant particles on the rear of the first filter 310. The first filter 310 may be a prefilter and the second filter 320 may be a HEPA filter, an ULPA filter, or a MEMBRANE filter.

It is preferable that the first filter 310 and the second filter 320 have a grip at the end for easy cleaning and replacement.

The fastening band 400 is connected to the rear of the face shield 100 to be worn on the rear part of the user's head. The fastening band 400 may be configured in a band type such that the face shield 100 can be worn downward from the top of the user's head or may be connected to both sides of the face shield 100 to be fastened on the rear part of the user's head by fasteners, that is, it can be implemented in various types that can be worn on the rear part of the user's head.

Hereafter, the flow state of air when a user wearing the portable protective device for preventing respiratory viruses according to the first embodiment of the present disclosure respires is described with reference to FIG. 5.

First, when a user breathes in, air purified by the air purifier 300 flows inside the face shield 100 through the air inlet 110. In this process, the elastic check valve 212 is reclined backward and opens the air intake hole 211, so the purified air flows to respiratory organs through the air intake hole 211.

Further, when the user breathes out, the check valve 212 returns and closes the air intake hole 211 and air flows upward along the air passage 130 through the air passage hole 120 formed at the lower portion of the face shield 100 and is then discharged outside.

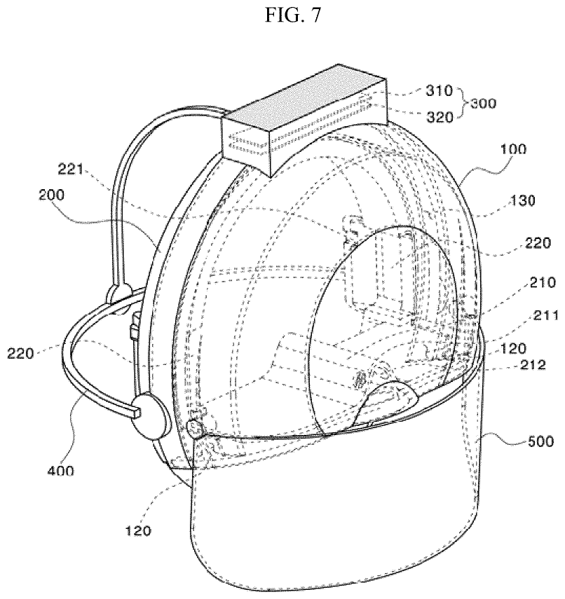

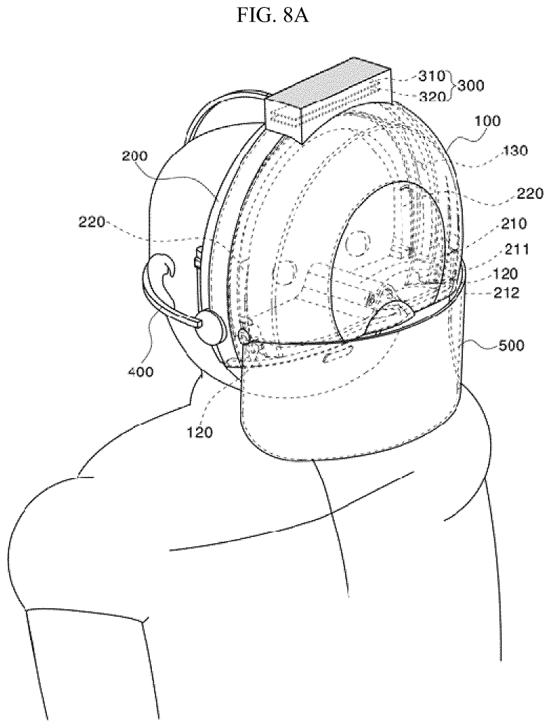

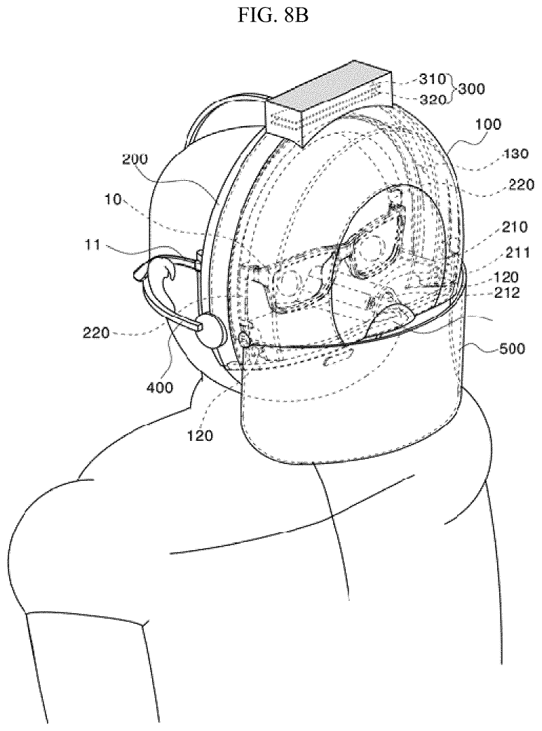

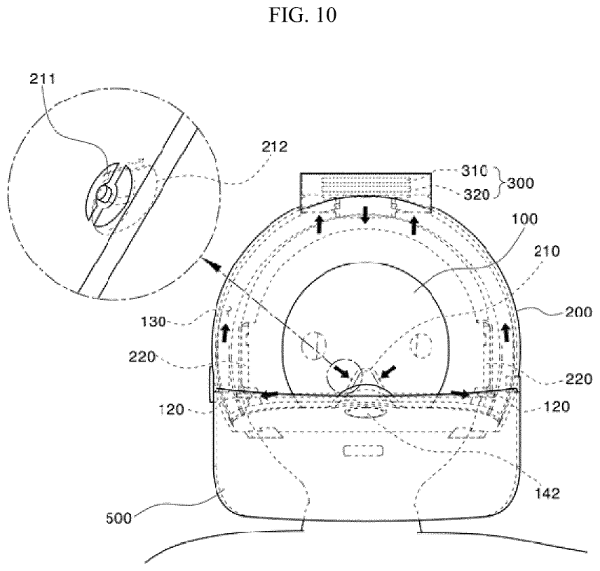

Hereafter, a portable protective device for preventing respiratory viruses according to a second embodiment of the present disclosure is described with reference to FIGS. 7 to 10.

Referring to FIGS. 7 to 10, a portable protective device for preventing respiratory viruses according to a second embodiment of the present disclosure is configured such that the face shield 100 is positioned to cover the user's eyes and nose except for the mouth. The second embodiment of the present disclosure is characterized in that a mouth shield 500 preventing the user's mouth from being exposed to the outside is coupled to the bottom of the face shield 100. When a user talks while taking food at a place like a restaurant, the mouth shield 500 prevents the respiratory viruses from being transmitted from another person positioned opposite to the user.

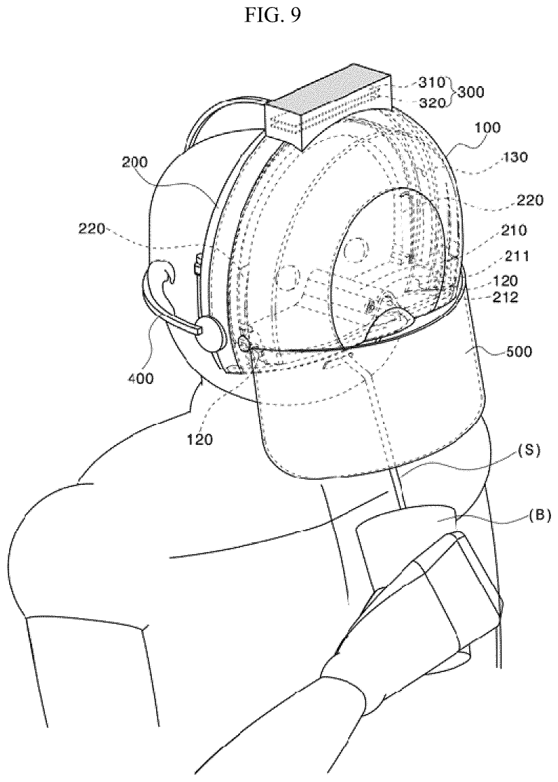

The mouth shield 500 can be rotated up and down not to interfere with the user taking food. As shown in FIG. 9, when a user takes drink B, the user can easily take the drink B through a straw B after rotating the mouth shield 500 a predetermined angle in the up-down direction. Even though a user takes not only drink, but food at a restaurant, similarly, the user can rotate the mouth shield 500 a predetermined angle in the up-down direction and then easily take the food.

An air outlet 142 is formed at the lower portion of the face shield 100 so that the sound from the user's nose and the sound from the user's mouth are combined and the voice is accurately transmitted to the outside. Accordingly, it is possible to efficiently transmit a voice while minimizing the defect in ability of transmitting sound of the face shield 100.

It is preferable that a filter 150 is installed in the air outlet 142 to prevent permeation of respiratory viruses.

Other components including the air purifier 300 and the fastening band 400 and the structure for airflow according to the second embodiment of the present disclosure are the same as those of the first embodiment described above, so they are not described in detail.

In general, since people have to take off masks in order to take food including drink, they are unavoidably exposed to respiratory viruses. However, according to the present disclosure, it is possible to take food with the face shield 100 for blocking respiratory viruses on, so it is possible to safely take food while being minimally exposed to respiratory viruses.

Further, the face shield 100 and the mouth shield 500 that is detachably coupled to the lower portion of the face shield 100 are separately manufactured such that the eyes and nose are protected the face shield 100 and only the mouth is protected by attaching the mouth shield 500 that can be moved up and down independently from the face shield 100. Accordingly, the device can be used as a device for prevention of epidemics which can minimize infection while a user takes meal at an eating house including a restaurant, which can contribute to activating business of eating houses including a restaurant.

Further, when a person has to sit in a seat for long time like an airplane, a train, an express bus, etc., he/she may unconsciously take off a mask while asleep and is unavoidably exposed to respiratory viruses in this case. However, the present disclosure provides a safe space for only the user even though the user has to sit in a seat for long time like an airplane, a train, an express bus, etc., whereby it is possible to prevent the user from being exposed to respiratory viruses.

Although blocking respiratory viruses was described above, the present disclosure may be used for various purposes such as blocking particulates.

Optimal embodiments were described above with reference to drawings. Although specific terms were used, there are used only to describe the present disclosure, not to limit meanings or the scope of the present disclosure described in claims. Accordingly, those skilled in the art would understand that various and equivalent modifications can be achieved from the embodiments. Therefore, the technical protective region of the present disclosure should be determined by the scope described in claims.

[Description of Reference Numerals]

| | |
|---|---|
| 100: face shield | 110: air inlet |
| 120: air hole | 130: air passage |
| 140: opening-closing type filter unit | 141: rotary guide |
| 142: air outlet | 143: coupling protrusion |
| 144: opening/closing plate | 145: hole |
| 146: handle | 150: filter |
| 160: insertion port | 170: cap |
| 200: respiration guide | 210: diaphragm |
| 211: air intake hole | 212: check valve |
| 220: glasses seat | 221: fixing groove |
| 300: air purifier | 310: first filter |
| 320: second filter | 400: fastening band |
| 500: mouth shield | |

What is claimed is:

1. A portable protective device for preventing respiratory viruses, the portable protective device comprising:
a face shield that can be worn on a user's face while covering user's eyes, nose, and mouth, has an air inlet for taking inside external air at a top thereof, and has an air passage formed around an edge thereof to form a passage through which air is discharged outside when the user respires;
a respiration guide that is coupled to surround a rear of the face shield, is brought in close contact with the user's face, and has a diaphragm at a center thereof to separate the eyes and respiratory organs of the user;
an air purifier that is connected to the air inlet on the top of the face shield and purifies and supplies external air to the air inlet; and
a fastening band that is connected to the rear of the face shield to be worn on a rear part of a user's head,
wherein an air intake hole is formed at the diaphragm so that air purified through the air purifier flows to the respiratory organs of the user through the air inlet, and a check valve that opens the air intake hole when the user breathes in and closes the air intake hole when the user breathes out is installed inside the diaphragm.

2. A portable protective device for preventing respiratory viruses, the portable protective device comprising:
a face shield that can be worn on a user's face while covering user's eyes and nose and has an air inlet for taking inside external air at a top thereof;
a respiration guide that is coupled to surround a rear of the face shield, is brought in close contact with a user's face, and has a diaphragm at a center thereof to separate the eyes and the nose of the user;
an air purifier that is connected to the air inlet on the top of the face shield and purifies and supplies external air to the air inlet;
a fastening band that is connected to the rear of the face shield to be worn on a rear part of a user's head; and
a mouth shield that is coupled to a lower portion of the face shield and prevents a user's mouth from being exposed to the outside,
wherein an air intake hole is formed at the diaphragm so that air purified through the air purifier flows to the respiratory organs of the user through the air inlet, and a check valve that opens the air intake hole when the user breathes in and closes the air intake hole when the user breathes out is installed inside the diaphragm.

3. The portable protective device of claim 1, wherein
the air purifier includes:
a first filter for primarily filtering out relative large particles; and
a second filter for secondarily filtering ultrafine contaminant particles on a rear of the first filter.

4. The portable protective device of claim 1, wherein an opening-closing type filter unit that is positioned ahead of the user's mouth to be able to open when the user talks is disposed at a lower portion of the face shield, and a filter is installed in the opening-closing type filter unit to prevent permeation of respiratory viruses.

5. The portable protective device of claim 4, wherein the opening-closing type filter unit 140 includes:
a rotary guide that has several air outlets spaced apart from each other with regular intervals therebetween so that voice of the user can be transmitted to the outside; and
opening/closing plates that are coupled to the rotary guide to open/close the air outlets by rotating to a side or another side by the user.

6. The portable protective device of claim 5, wherein the opening/closing plate has a hole that is biased from the air outlet when the opening/closing plate is rotated to a side and that communicates with the air outlet when the opening/closing plate is rotated to another side, and a handle that is provided to easily rotate the opening/closing plate.

7. The portable protective device of claim 5, wherein an edge of the rotary guide is partially cut to limit a rotation range of the opening-closing plates, whereby stopping steps are formed at both sides.

8. The portable protective device of claim 4, wherein an insertion port through which a straw is inserted so that the user can take drink and a cap for opening/closing the insertion port are formed at a center of the opening/closing type filter unit.

9. The portable protective device of claim 1, wherein a glasses seat is formed on two sides of an inner surface of the respiration guide to prevent interference with an eyeglass frame when the user wears glasses, and a fixing groove for fixing a temple is formed at an end of the glasses seat.

10. The portable protective device of claim 2, wherein the mouth shield is configured to be rotatable.
